(19) United States
(12) Patent Application Publication
(10) Pub. No.: US 2021/0394718 A1
(43) Pub. Date: Dec. 23, 2021

(54) Semi-Automated, Self-Contained Mobile Wash System

(71) Applicant: Nash Industrial Solutions, Inc., Alexander, AR (US)

(72) Inventor: Casey Craft, Alexander, AR (US)

(21) Appl. No.: 17/356,149

(22) Filed: Jun. 23, 2021

Related U.S. Application Data
(60) Provisional application No. 63/042,703, filed on Jun. 23, 2020.

(51) Int. Cl. B60S 3/06; B60S 3/04

(52) U.S. Cl. CPC B60S 3/063; B60S 3/047

(57) ABSTRACT

A mobile cleaning system has a mobile unit allowing for movement of the cleaning system to and around a static vehicle for cleaning, a main cleaning assembly for applying cleaning fluids to a surface of the static vehicle and for scrubbing the surface of the static vehicle (where the cleaning assembly has the ability to pivot, rotate, and/or tilt for various cleaning purposes), a self-contained fluid supply system providing the cleaning fluids used by the cleaning assembly, and a operator control assembly allowing an operator to ride the mobile unit and selectively operate the components of the cleaning system.

### CROSS REFERENCE TO RELATED APPLICATIONS

This application claims priority to U.S. Provisional Application No. 63/042,703, filed on Jun. 23, 2020, and entitled “Large Vehicle Mobile Wash System.” Such application is incorporated by reference herein in its entirety.

### BACKGROUND OF THE INVENTION

Washing systems for large vehicles are generally very large, very expensive, and placed in a static location. In a static location, it is required that the large vehicle be moved to the washing system in order for washing to occur. For large vehicle owners, particularly those with large fleets, moving each individual vehicle to the static washing system can take a considerable amount of time. Further, because special licenses are needed to drive many large fleet vehicles, an appropriate licensed operator must be on hand to move the large vehicle to the cleaning station even though it may be better for business to allow licensed operators to perform more important jobs. To avoid these problems, it would be desirable to develop a system for washing large vehicles that is portable so that it can be taken to the location of the vehicles that require washing instead of requiring the movement of all of the vehicles individually, while still providing a thorough washing of the vehicles.

### BRIEF SUMMARY OF THE INVENTION

The present invention is directed to a self-contained and semi-automated mobile wash system with ability to navigate to and around static vehicles for cleaning of the static vehicles. The mobile wash system is particularly suitable for use in cleaning large vehicles, including large fleets of large vehicles. The mobile wash system is designed to travel out to the fleet in parking lots or maintenance yards so that a static vehicle or even multiple static vehicles can be washed without requiring the vehicles to be moved. In certain implementations, vehicle and fleet types serviceable by this mobile wash system include general trucking, transit fleets (bus and rail), RV and car dealerships among others. In certain embodiments, the system is self-contained and semi-automated, making it easy for operation by a single attendant, with the controls mounted from one end of the washer with stand-up, ride-along controls.

These and other features, objects and advantages of the present invention will become better understood from a consideration of the following detailed description in conjunction with the drawings as described following:

### BRIEF DESCRIPTION OF THE SEVERAL VIEWS OF THE DRAWINGS

FIG. 1 is a first-side perspective view of one embodiment of the mobile cleaning system of the present invention, with the brush of the cleaning assembly removed for clarity.

FIG. 2 is a bottom perspective view of one embodiment of the mobile cleaning system of the present invention, with the brush of the cleaning assembly removed for clarity.

FIG. 3 is a second-side perspective view of one embodiment of the mobile cleaning system of the present invention, with the brush of the cleaning assembly removed for clarity.

FIG. 4 is an end view of one embodiment of the mobile cleaning system of the present invention, with the brush of the cleaning assembly removed for clarity.

FIG. 5 is a second-side view of one embodiment of the mobile cleaning system of the present invention, with the brush of the cleaning assembly removed for clarity.

FIG. 6 is a top view of one embodiment of the mobile cleaning system of the present invention, with the brush of the cleaning assembly removed for clarity.

FIG. 7 is a detailed view Section A as shown in FIG. 1.

FIG. 8 is a detailed view of Section C as shown in FIG. 7.

FIG. 9 is a detailed view of Section D as shown in FIG. 1.

FIG. 10 is a detailed view of Section B as shown in FIG. 2.

FIG. 11 is a detailed view of Section F as shown in FIG. 2.

FIG. 12 is a top view of one embodiment of the operator assembly of the present invention, as shown in Section E of FIG. 6.

FIG. 13 is a top view of one embodiment of the hydraulics system of the present invention, as shown in Section G of FIG. 6.

FIG. 14 is a perspective view showing one embodiment of the mobile cleaning system of the present invention engaged in cleaning a side surface of a trailer of a large vehicle.

FIG. 15 is a perspective view showing one embodiment of the mobile cleaning system of the present invention engaged in cleaning a side surface of a truck portion of a large vehicle.

FIG. 16 is a side view showing one embodiment of the mobile cleaning system of the present invention engaged in cleaning a side surface of a truck portion of a large vehicle.

FIG. 17 is a side view showing one embodiment of the mobile cleaning system of the present invention engaged in cleaning a side surface of a trailer portion of a large vehicle.

FIG. 18 is a perspective view showing one embodiment of the mobile cleaning system of the present invention engaged in cleaning a side surface of a trailer portion of a large vehicle.

FIG. 19 is a perspective view showing one embodiment of the mobile cleaning system of the present invention engaged in cleaning a side surface of a trailer portion of a large vehicle.

FIG. 20 is a perspective view showing one embodiment of the mobile cleaning system with the cleaning assembly in the stowed position.

FIG. 21 is a perspective view showing one embodiment of the moving cleaning system with the cleaning assembly in the stowed position and with the brush removed for clarity.

FIG. 22 is a perspective view showing one embodiment of the pivoting functionality of the cleaning assembly of the present invention.

FIG. 23 is a perspective view showing one embodiment of the pivoting functionality and tilting functionality of the cleaning assembly of the present invention.

FIG. 24 is a side view showing one embodiment of the titling functionality of the cleaning assembly of the present invention.

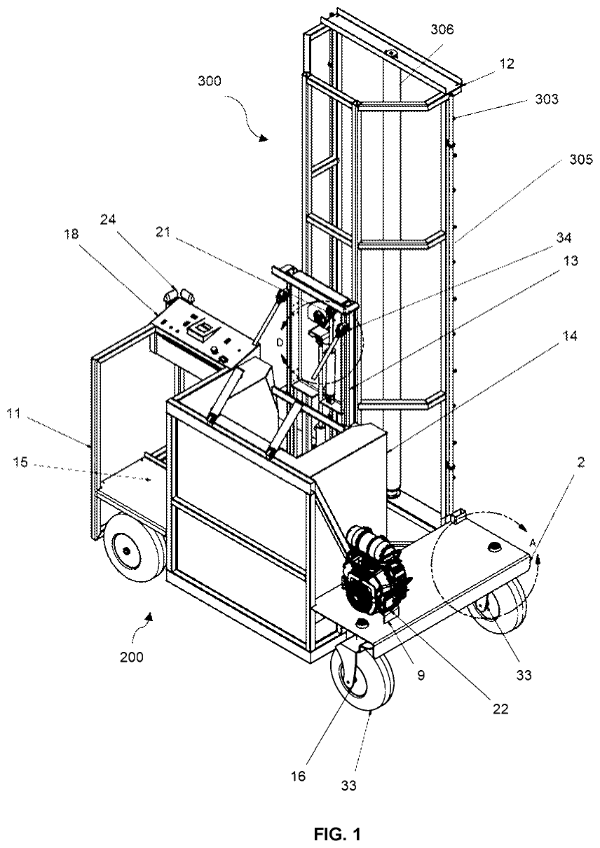

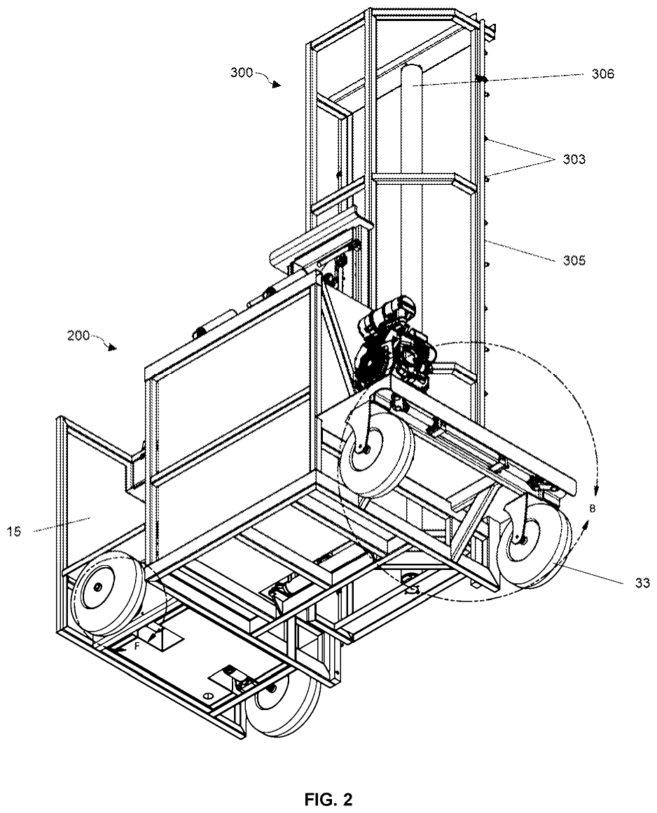

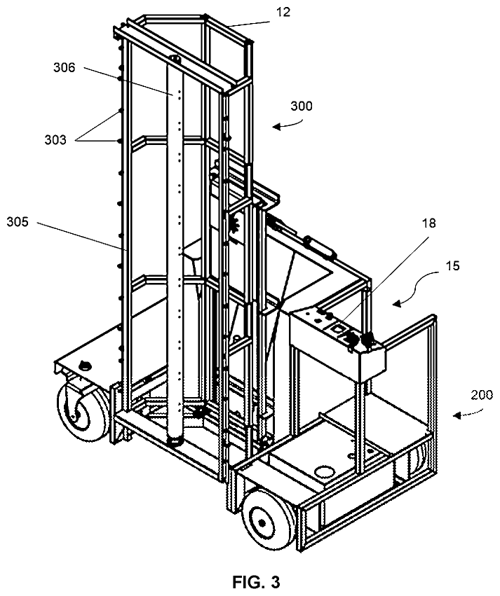

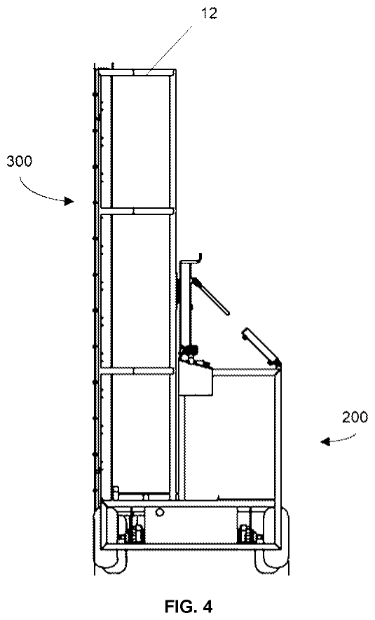

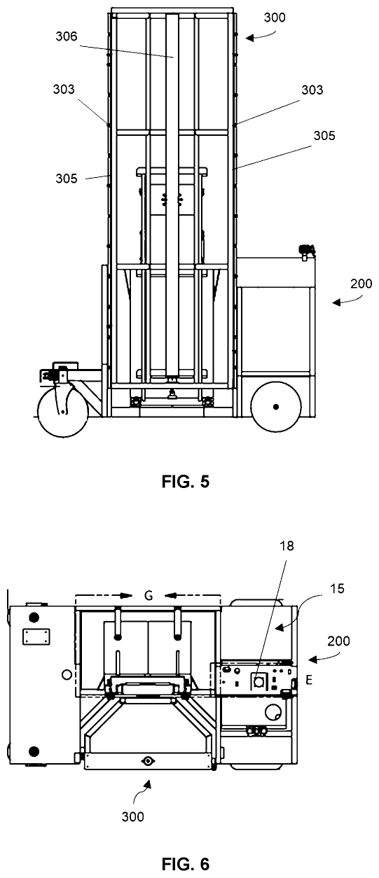

### DETAILED DESCRIPTION OF THE PREFERRED EMBODIMENT(S)

Generally speaking, the present invention in certain embodiments is directed to a self-contained and semi-automated mobile wash system 100. While the primary purpose of the invention is to provide a system 100 that is capable of efficiently cleaning large vehicles 400 (and fleets of large vehicles), it is understood that the invention can be used for cleaning of any equipment or other items as well. Still, the benefits of the system of the present invention may be most effectively recognized when the system 100 is utilized for cleaning large vehicles 400, and therefore, the invention will primarily be described in connection therewith. To provide a self-contained and semi-automated mobile wash system 100 operable by a single operator, the system of the present invention may be primarily described with regard to two major functionalities: (a) mobility, allowing the single self-contained system to be moved to the vehicle(s) rather than moving each individual vehicle to a static cleaning station and (b) cleaning, providing a self-contained system and mechanism for cleaning each vehicle in the fleet of vehicles using the mobile system. In this regard, the mobile system 100 of the present invention includes components that provide the mobilization capabilities and components that provide the cleaning capabilities. The components combined create a self-contained mobile wash system 100 capable of traveling out to a parked vehicle 400 (or fleet of vehicles) to perform vehicle wash operations. Of course, it is understood that while these components may be described individually or in certain groupings, in reality these components may all be integral to a single assembly and single system for providing mobile cleaning of vehicles.

As noted above, the system 100 of the present invention is generally made up of components facilitating the mobilization capabilities and those facilitating the cleaning capabilities. While the mobilization capabilities may technically allow the present invention to be defined as a vehicle because the present invention is capable of transporting a person (namely, the operator) to a new location to perform the cleaning operation, in order to describe the invention without reference to the term “vehicle” (which may be reserved, for clarity's sake, for identifying the vehicle 400 to be cleaned by the present invention) the present invention may be described with reference to a “mobile unit” 200. In this regard, and very generally speaking, the components facilitating the mobilization capabilities of the present invention provide a mobile unit 200 capable of transporting an operator to a cleaning site (such as a parking lot) for the cleaning of one or more vehicles 400 (such as a truck, RV, etc.), the cleaning facilitated by a cleaning system of components providing the cleaning capabilities, including a main cleaning assembly 300. The mobile unit 200 created by the mobilization components and the cleaning system (including the main cleaning assembly 300) provided by the cleaning components are all described in more detail below.

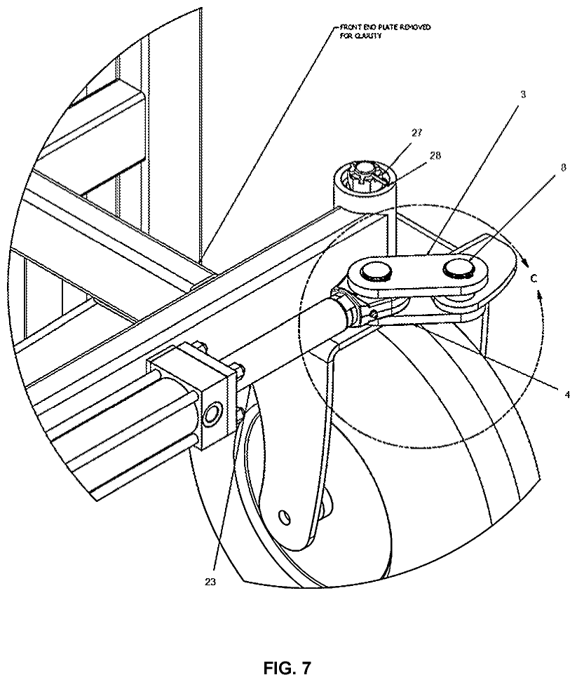

As shown in the figures, the mobile unit 200 includes a carriage 11 providing the basic body/frame of the mobile unit 200, which provides a structure in or on which the operator can be positioned during use of the system 100 and a structure in or on which the components facilitating the cleaning capabilities can be positioned. The carriage 11 is preferably built to allow a single operator to operate the invention, which allows a single operator to efficiently clean a vehicle 400 or multiple vehicles without the need to move each of the vehicles to some static cleaning station. The mobile unit 200 includes a set of tires 33 on the underside of the mobile unit 200, allowing the mobile unit 200 to move between locations (such as from its stored location to a parking lot for cleaning operations, etc.). The set of tires 33 may be, for example, four, flat-free, rubber tires sized for the ability to traverse varying terrains such as paved parking lots as well as gravel or dirt lots where vehicles may be stationed for cleaning. In the preferred embodiments, eighteen-inch or twenty-inch tires 33 may be the most effective for allowing use on multiple types of terrains. The tires 33 may be attached to the mobile unit using pivotable attachment means, as shown in detail in FIGS. 7-8, allowing the tires 33 to rotate in order to facilitate turning of the mobile unit 200, and the pivoting of the tires may be facilitated by steering hydraulics 23. The tire pivot means may include a set of linkage plates 3, 4, which are coupled to and link the steering hydraulics 23 and castors 16 of the tires 33 to facilitate the pivotable movement of the tires 33. Steering link pins 8 may be used to facilitate the linkage, as shown.

Movement of the mobile unit 200 is preferably facilitated by an electric motor 22, thereby creating a mobile cleaning system 100 that can be powered and moved from site-to-site for cleaning different vehicles 400. Alternatively, a gas-powered engine 22 may be used to facilitate movement of the mobile system 100. In one embodiment, for example, a twenty-five-horsepower gasoline-powered engine may be utilized. In any event, it may be seen that an electric start or ignition is used on the gas-powered embodiment, which can be initiated by the operator using a key or push-to-start capabilities to engage a battery to start the ignition. It may be seen that a charging system can be included to allow for the recharge of power to the battery for multiple uses over a prolonged period. Further, like can be found in many existing vehicles, an alternator charging system can be included to facilitate recharging of the battery. In the preferred embodiment, the carriage 11 may be made from a powder coated or stainless-steel material and may include tie down lugs for transporting or towing the mobile system 100, such as, for example, on a trailer or other large transport vehicle. Further, the mobile unit 200 may include a front-end plate 2 that acts as a shelf for the motor 22 (which may rest on an engine mount 9 of the front-end plate 2).

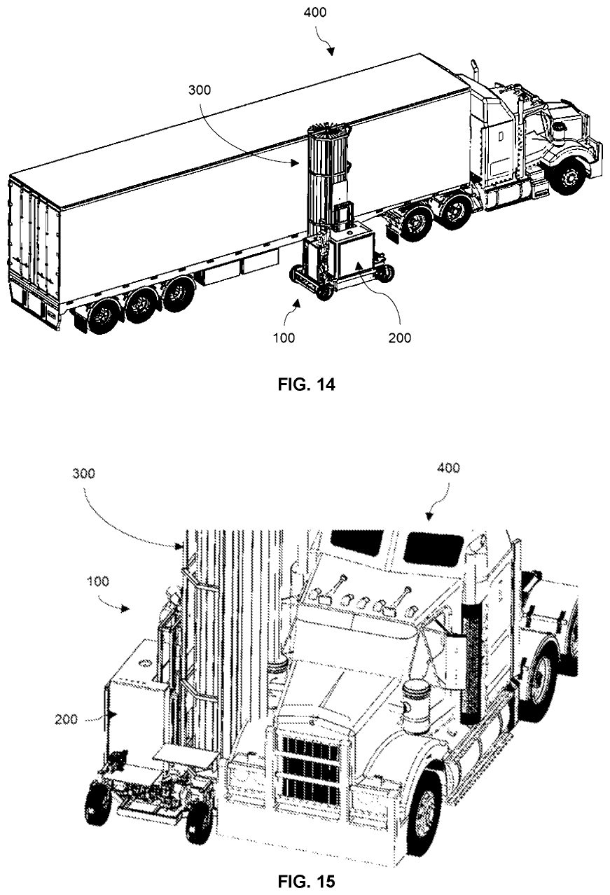

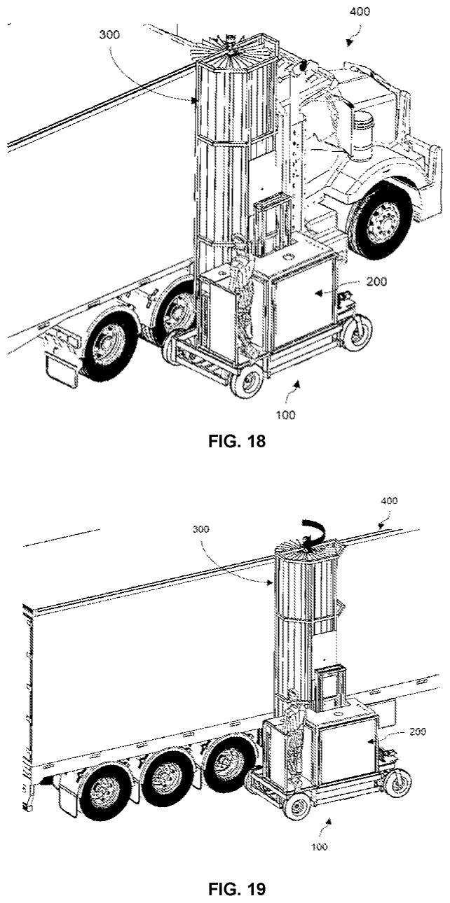

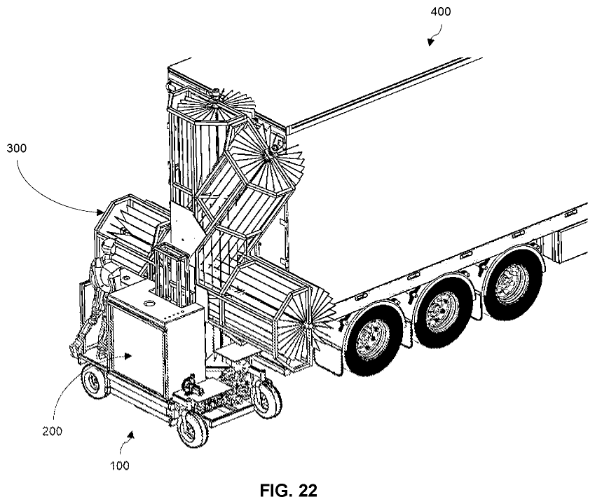

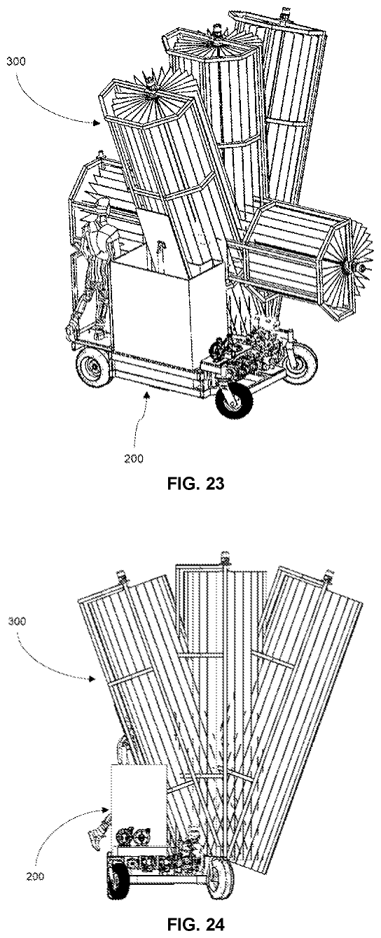

As noted above, the mobile unit 200 of the system 100 is built to allow an operator to be positioned on or in the carriage 11. In this regard, the mobile unit 200 includes an operator cab 15 which provides the space and structure on which an operator can be positioned to operate the mobile cleaning system 100. In the preferred embodiment, the operator cab 15 is configured to allow the operator to be in a standing position (as shown, for example, in FIGS. 14-24) during operation of the mobile cleaning system 100. Alternatively, it is possible to provide an operator cab 15 that allows the operator to be in a sitting position during operation; however, it may be seen that the overall dimensions of the mobile cleaning system 100 can be reduced, and the ability of the operator to operate the mobile cleaning system 100 can be increased, if the operator cab 15 is configured to allow the operator to stand during use. The preferred dimensions of the mobile unit 200 are five feet (width) by eight feet (length), although other dimensions may be used in alternative embodiments.

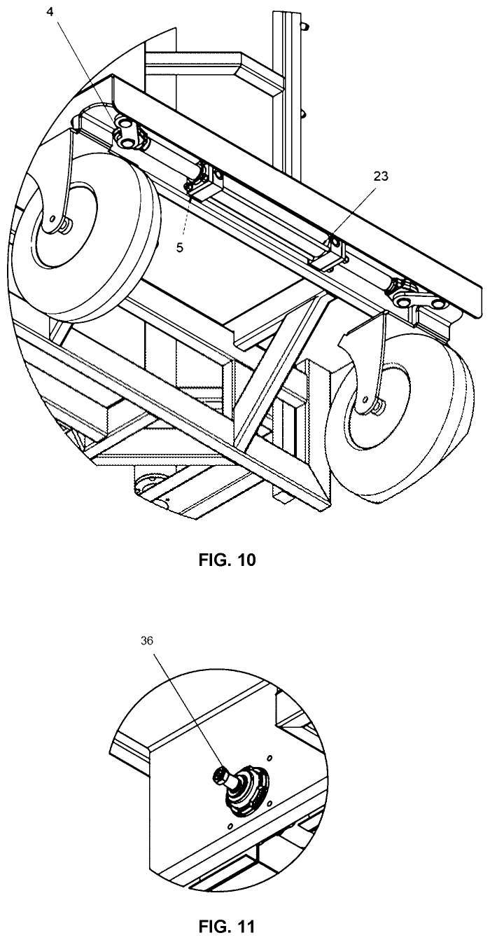

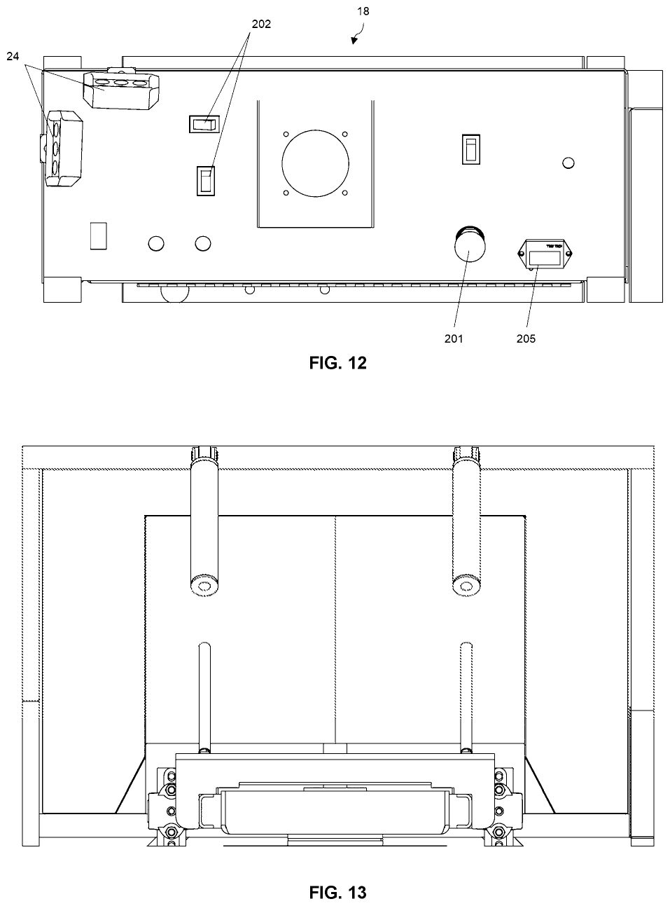

The operator cab 15 includes an operator assembly 18 (shown in more detail in FIG. 12), which includes various functional controls that allow the operator to control and operate the mobile cleaning system 100 of the present invention. In the preferred embodiment, hydraulic controls 102 are used, and the engine/motor 22 drives the hydraulic pumps that operate the wheels, water pump, detergent pump, side brush, spray boom, and electrical system. The hydraulic controls allow for steering the mobile unit 200, which may, for example, be done using a joystick control 201 with auto-center steering for ease of operation. The controls 202 may be dash-mounted controls that provide the operator with the ability to control various aspects of the system. The operator assembly 18 may, for example, include controls 202 for starting and stopping the engine (which, as noted above, may be key-started or push-button-started), for steering the unit (including forward, reverse, and turning capabilities), for engaging the pressure pump, for engaging the detergent pump, for mobilizing the cleaning assembly 300 (including the ability to stow, deploy, move up and down, and tilt in and out), for operating the manual spot spray gun (including pressure spray and detergent spray capabilities), for turning headlights 24 on and off, for engaging the brush (including clockwise or counterclockwise rotation of the brush), and even speed controls. The operator assembly 18 may also include dash-mounted displays 205 that show the speed, fuel/battery level, and other similar features of the system to provide the operator with information regarding the operation of the unit.

While the components above may be described as providing the mobilization capabilities of the system 100, a number of components also provide the cleaning capabilities of the mobile cleaning system 100 of the present invention. These cleaning components are positioned in or on the mobile unit 200 and allow for a fully self-contained cleaning solution for vehicles 400. In this regard, the system 100 not only includes components that perform the actual cleaning of the vehicles 400, but also components that store and supply cleaning supplies for use during the cleaning operations. To facilitate the actual cleaning of vehicles 400, the mobile cleaning system 100 includes a main cleaning assembly 300, a hand-held spray assembly, a water tank 14, one or more detergent tanks, and a pumping system operable to provide the water and/or detergent to the cleaning assembly 300 and hand-held spray assembly during cleaning of vehicles 400. Each of these components is described more fully below.

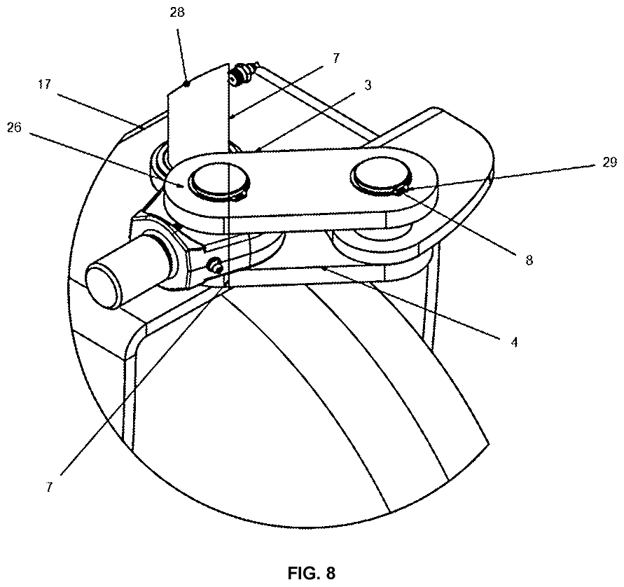

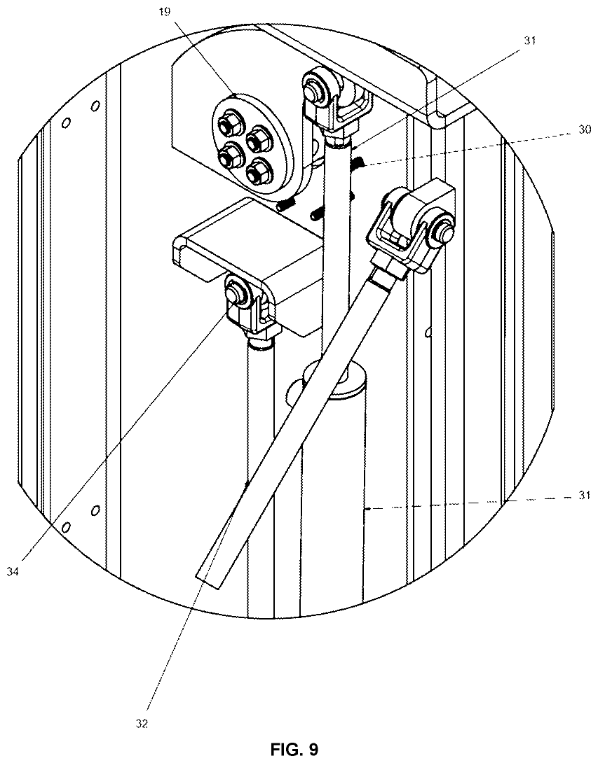

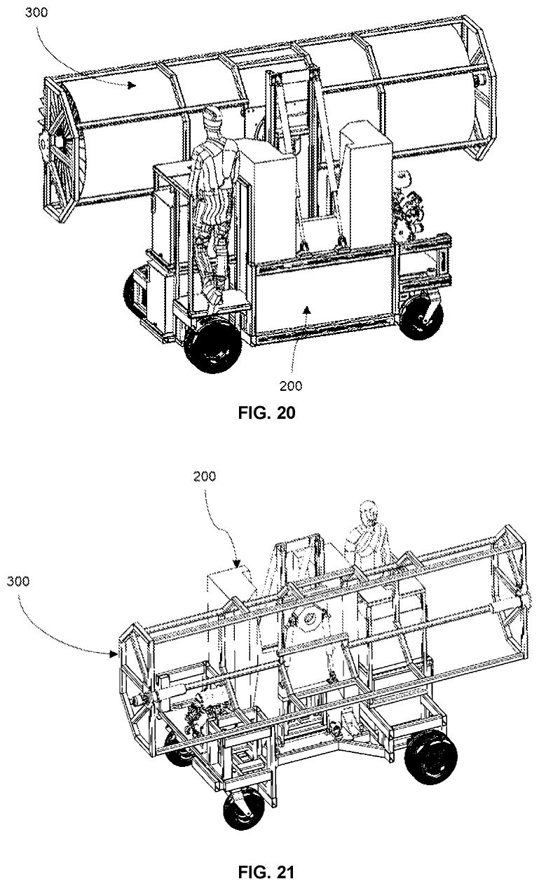

Generally speaking, in the preferred embodiment of the present invention, the main cleaning assembly 300 includes a brush 301 and spray boom 302, where the brush 301 includes bristles 304 used for scrubbing the vehicle 400 during cleaning and where the spray boom 302 includes a pipe (or multiple pipes) 305 with attached nozzles 303 for distributing water and/or detergent onto the vehicle 400 during cleaning. While the preferred embodiment has the main cleaning assembly 300 including both the brush 301 and spray boom 302, it is understood that in various embodiments, the main cleaning assembly 300 may omit one component, so that the main cleaning assembly 300 is primarily a brush 301 or primarily a spray boom 302. As shown, the main cleaning assembly 300 is preferably mounted to the mobile unit 200 in a manner allowing the main cleaning assembly 300 to move along a plane parallel to the mobile unit 200 (i.e., pivoting from a vertical position and a horizontal position without moving toward or away from the mobile unit 200, as shown for example in FIGS. 20-22) or along a plane perpendicular to mobile unit 100 (i.e., tilting toward and away from the mobile unit 200, as shown for example in FIG. 24). Furthermore, the main cleaning assembly 300 can be rotated along its own axis (i.e., rotating to position different sides of the main cleaning assembly 300 toward the vehicle 400 to be cleaned, as shown in FIG. 19). For purposes of describing the invention, the term “pivot” is used to refer to the movement of the main cleaning assembly 300 from a vertical position to horizontal position adjacent to the mobile unit 200, the term “tilt” is used to refer to the movement of the main cleaning assembly 300 toward and way from the mobile unit 200, and the term “rotate” is used to refer to the spinning of the main cleaning assembly 300 around its own axis. These movements of the main cleaning assembly 300 not only allow it to move as needed for different cleaning scenarios, but also allows the main cleaning assembly 300 to be moved to a stow position (see FIGS. 20-21) for easier storage and transport. In one embodiment, the tilt of the main cleaning assembly 300 can be up to ten degrees, which can assist in maneuvering the main cleaning assembly 300 to avoid vehicle 400 mirrors, handrails, or other vehicle parts. With these movement capabilities the main cleaning assembly 300 can said to move between one or more positions for cleaning (each a “cleaning position” and the most preferable cleaning position being the “primary cleaning position”) and a position for storage (a “stow position”). The pivoting, tilting, and rotating of the main cleaning assembly 300 can be driven by hydraulics 13 and can be selectively performed by the operator using controls on the operator assembly 18. The controls provide the operator the ability to select the amount of pivot, tilt, and/or rotation, along with the speed and direction of pivot, title, and/or rotation. Bluetooth functionalities may be incorporated into the controls to allow the operator to adjust the movements from a hand-held spray assembly, allowing the operator to adjust the amount of movement and speed or direction of movement even when the operator is not positioned on the mobile unit 200. It may be seen that the operator, then, can put the mobile unit 200 in park, take a position in a place off the mobile unit 200 that gives a better view of the main cleaning assembly 300, and make any adjustments necessary to more efficiently clean the vehicle 400. A detailed view of one embodiment of the cleaning assembly 300 hydraulics 13 is shown in FIG. 9. As shown, a pivot hydraulic 31 and a pivot shaft 19 can be utilized to provide the pivotable movement of the cleaning assembly 300, while tilt hydraulics 32 can be utilized for the tilting movement.

In the preferred embodiment, the stow position is characterized as when the main cleaning assembly 300 is pivoted to a horizonal position, and preferably, without any tilting, so that the main cleaning assembly 300 is preferably substantially parallel to the mobile unit 100 and horizontally positioned, as shown for example in FIGS. 20-21. While the stow position is preferably where the main cleaning assembly 300 is horizontally positioned and substantially parallel to the mobile unit 100 (i.e., no tilt), the cleaning positions can be any other position of suitable use for the main cleaning assembly 300. Various cleaning positions are shown, for example, in FIGS. 14-19 and 22. In this regard, cleaning positions include those where the main cleaning assembly 300 is pivoted any number of degrees beyond the horizontal stow position, tilted or not tilted to any degrees, and rotating or not rotating at any speed and in any direction. The primary cleaning position is characterized as when the main cleaning assembly is pivoted to a substantially vertical position (as shown, for example, in FIGS. 14-19 and 22-24), regardless of the amount of tilt or rotation. This cleaning position allows the main cleaning assembly 300 to cover the entirety of the vehicle 400, from bottom to top, allowing for the application of fluids from the spray boom 302 or the brush 301 to the vehicle 400 most efficiently. It is understood, however, that the main cleaning assembly 300 can be pivoted between its substantially vertical position and its substantially horizontal position to place the main cleaning assembly 300 in any number of pivoted positions, which would allow the main cleaning assembly 300 to be used as needed to clean different sized or shaped vehicles. Furthermore, it may be seen that degree of each of the pivot, tilt, and rotation of the main cleaning assembly 300 can be modified as desirable during a particular cleaning operation. In one embodiment, it may be seen that the main cleaning assembly 300 includes both a brush 301 and a spray boom 302, and while the whole cleaning assembly 300 can be pivoted or titled, it may be seen that only the brush 301 is rotatable, which assists in the scrubbing functionality of the brush 301. Alternatively, it may be seen that in one embodiment the cleaning assembly 300 includes a brush 301 and spray boom 302 and only the brush 301 is pivoted, titled, and/or rotatable. In one embodiment, the spray boom 302 and brush 301 are mounted to a frame 12 that is coupled to the mobile unit 200, and the frame 12 may include splash shields to prevent fluids from entering the mobile unit 200.

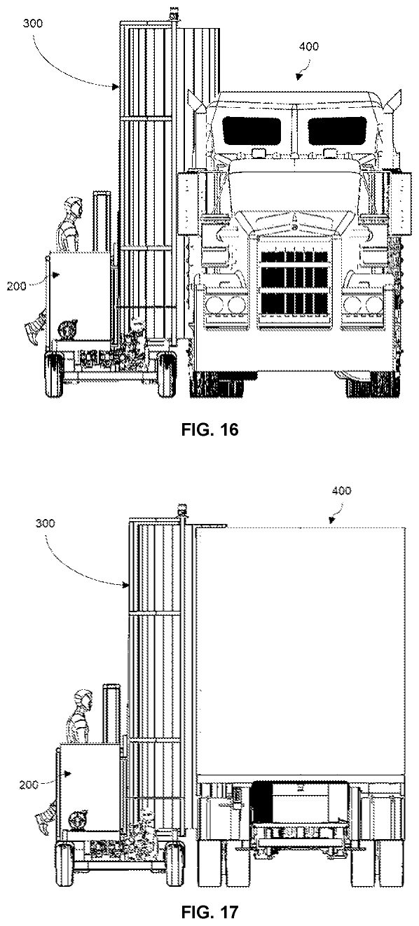

As noted, the brush 301 of the main cleaning assembly 300 is a brush having bristles 304 for scrubbing the surface of the vehicle 400 to be cleaned. In the preferred embodiment, the bristles 304 are made a foam or polyethylene material, which allows for adequate scrubbing to clean the vehicle 400 without damaging the paint of the vehicle 400. The bristles 304 may extend outwardly from a shaft 306 of the brush 301 from one or more sides of the brush 301, providing the ability for the brush 301 to scrub from one or more directions. In the preferred embodiment, bristles 304 extend outwardly around the entire shaft 306, providing 360 degrees of scrubbing action. The shaft 306 may be made of aluminum and may have a diameter of approximately 4¾″ or may be modified as desired to provide a brush 301 of an appropriate size and material. While the height of the brush 301 can be modified as needed, in the preferred embodiments, the height of the brush 301 is either twelve feet or fourteen feet, which allows for the most efficient cleaning of common types of large equipment, allowing the brush to extend the entire vertical height of the vehicle 400, as shown in FIGS. 16-19. Furthermore, the diameter of the brush 301 can be modified as desired, but the preferred embodiment includes a brush 301 having a diameter ranging from forty-two inches to forty-eight inches. As noted in various embodiments the cleaning assembly 300 includes a spray boom 302, which may be included in addition to the brush 301 or may be the primary cleaning means of the cleaning assembly 300. In one embodiment, as noted, the spray boom 302 is pivotable between a horizontal stow position and a vertical cleaning position (with other cleaning positions therebetween). The spray boom 302 preferably includes one or more pipes 305 with attached nozzles 303 for distributing spray from the tank(s) of the mobile cleaning system 300. In one embodiment, the spray boom 302 of the present invention includes nozzles 303 that are offset from the centerline of the pipe 305 by fifteen degrees, with nozzles 303 placed in both forward and reverse positions. This provides a spray nozzle 303 pattern having an approximately forty-degree fan spray, providing the complete coverage of spray on the vehicle 400 to be cleaned. It may be seen that the best coverage can be realized when the spray boom 302 is positioned approximately eighteen inches from the vehicle's surface 400 and when the spray boom 302 is pivoted to it's vertical cleaning position. A depth sensor can be coupled to the cleaning assembly 300 to assist the operator in identifying the proper distance to the vehicle 400 being washed. Furthermore, the mobile cleaning system 100 may be preprogrammed with different pre-set cleaning modes, which, when selected, automatically pivot, tilt, and/or rotate the main cleaning assembly 300 or the brush 301 or spray boom 302 individually according to the pre-set amounts. In this regard, the cleaning system 100 may be semi-automated, allowing the operator to select a pre-set cleaning mode and simply monitor the cleaning to make sure the system is efficiently cleaning the vehicle 400. One or more splash shields 307 may be positioned around the main cleaning assembly 300 or otherwise between the main cleaning assembly and the operator cab 15 to prevent fluids from splashing the operator of the mobile cleaning system 100. For example, transparent panels (which may be constructed from clear polycarbonate) may be placed in front of the operator cab 15 and over the operator cab 15, and may be mounted to a shield-frame made from stainless steel and/or aluminum to support the splash shield(s).

In addition to the main cleaning assembly 300, in one embodiment the mobile cleaning system 100 includes a hand-held spray assembly to allow for manual spot cleaning by the operator, particularly for hard-to-reach areas. In one embodiment, the hand-held spray assembly may include multiple hand-held spray devices, one for the spray of water only and one for the spray of detergent or a water-detergent combination. This allows the hand-held spray assembly to be used for applying detergent and also for rinsing without detergent. The mobile cleaning system 100 may include a control switch 202 (either at the operator assembly 18, at a different control location on the carriage 11, or integral to the hand-held spray assembly) to allow the operator to selectively switch between operating the main cleaning assembly 300 and the hand-held spray assembly. For example, the hand-held spray assembly may be selectively operated using a trigger on the hand-held spray device itself. In one embodiment, the hand-held spray assembly is hung on the carriage 11 using a holster or other mounting device. This mounting device may be positioned on the carriage 11 such that the operator can use the hand-held spray assembly while positioned on or in the carriage 11 or may be positioned on the carriage 11 such that the operator can access the hand-held spray assembly only from a position off of the carriage 11 (such as when the operator is standing on the ground).

In addition to the main cleaning assembly 300 and the hand-held spray assembly, which power the actual cleaning of the vehicle, the mobile cleaning system 100 also includes components for storing and supplying cleaning fluids to the cleaning components, providing a self-contained cleaning system that gets all of the cleaning fluids it needs during operation from the on-board supplies (and which can be refilled during uses to make sure the on-board supply levels remain sufficient for cleaning operations). Because many cleaning operations require water to soak and rinse the vehicle's surfaces, a water tank 14 is positioned on or in the carriage 11 to allow for on-board water storage. It is preferred that the water tank 14 be at least a 200-gallon tank in order to provide a sufficient amount of water for cleaning a fleet of large vehicles, although other sizes may be employed in alternative embodiments. The water tank 14 is preferably constructed from stainless steel, providing a durable water storage solution. In one embodiment, the water tank 14 can be vented for quick refill from a remote tank or other water supply. In addition, the water tank 14 may include a built-in float valve with a standard water hose fitting, allowing the operator to use a water hose from a water supply for filling the water tank 14. Filling, drainage, and bypass lines may also be included. A water pump is fluidically connected to the water tank 14 and is used to operate the spray boom 302 and hand-held spray assembly by supplying pressurized water for cleaning operations. The water pump is preferably a hydraulically powered centrifugal pump providing five to ten gallons per minute of water at a pressure of at least 120 psi. In one embodiment, a water bypass line bypasses water to the water tank 14.

While the water tank 14 supplies water as the working fluid (allowing for soaking and rinsing of the vehicles), for best cleaning of vehicles, detergent or other washing solutions can also be used. For purposes of describing the invention, the term “detergent” may be used generally to refer to any cleaning solution, such as car shampoos, soaps, cleaning chemicals, or any other available cleaning solution. The ability to store one or more detergents on-board the mobile unit allows the operator to not only soak and rinse the vehicle surface with water but to apply detergents that can aid in the removal of dirt and grime from the body of the vehicle. Like with water tank 14, in order to allow for the self-contained mobile cleaning of the preferred embodiments of the present invention, one or more detergent tanks are included positioned on, in, or to the mobile unit. In the preferred embodiment, two detergent tanks are utilized, allowing for different detergents to be used for different cleaning operations as desired (for example, one detergent can be a shampoo for removing dirt or grime from the vehicle's surface and the other may be a wax that provides an extra shine to the vehicle once cleaned). The detergent tanks may be, for example, five-gallon tanks positioned on a shelf or compartment of the mobile unit, allowing for the easy refilling of detergents when empty. While it is contemplated that one or more detergent pumps can be used to supply detergent from the tank(s) to the cleaning assembly, in one embodiment, the water pump is also fluidically connected to one or more of the detergent tanks, allowing for simultaneous application of detergent(s) and water during cleaning. A downstream detergent meter may be included to allow the operator to identify the amount of detergent applied during cleaning, and in one embodiment a selector switch is coupled to the pump, allowing the operator to selectively switch between water-only application and dual water-detergent application. This allows the operator to rinse the vehicle after applying detergent by simply selecting the water-only application so that no additional detergent is applied during rinsing. As noted above, in one embodiment, a water bypass line bypasses water back to the water tank. In order to ensure that no detergent is supplied to the water tank, the detergent may be injected into the water line after the pump and bypass line, allowing clean water to be sent via bypass back to the water tank while supplying detergent and water to the cleaning assembly components for cleaning of the vehicle.

Safety features may be built into the mobile unit to minimize the risks of accidents during operation. For example, a system kill switch or emergency stop may be included to minimize risks associated with failure. In addition, a low-oil shutdown mechanism for shutting down the engine in the event a low oil level is detected can be included in order to minimize the risk of wearing down or otherwise damaging the engine. Further, because the system includes mobilized equipment, headlights for night or low-light operations may be used, allowing the operator to have better visibility (and to allow others to be able to see the mobile unit easier), an audible horn may also be included to allow the operator to alert others to the positioning of or movement of the unit, and a parking brake system may be incorporated to allow for safe parking of the mobile unit. Another safety feature that may be included is that pre-programmed brush functions can be utilized to automatically deploy and stow the brush assembly so that the mobile unit is automatically returned to a safe state when not in use. A lower water pump system shut-off can be included that automatically shuts off the system in the event of low water in the water tank, and to reduce pump wear, a water pump bypass back to the water tank may be incorporated. Further, because there are a number of fluids utilized in the mobile unit, fluid systems design for ease of freeze protection may be utilized. Finally, splash shields may be positioned as needed, such as around the operator cage for operator protection and the operator assembly protection. In one embodiment, the mobile unit has a maximum travel speed of three miles per hour and a working speed of zero to two miles per hour to further reduce any risks for injuries or other accidents.

Unless otherwise stated, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. It will be apparent to those skilled in the art that many more modifications are possible without departing from the inventive concepts herein.

All terms used herein should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. When a grouping is used herein, all individual members of the group and all combinations and subcombinations possible of the group are intended to be individually included in the disclosure. When a range is used herein, all subranges within that range and all points within that range are intended to be individually included in the disclosure.

1. A mobile cleaning system comprising a cleaning assembly pivotally mounted to a mobile unit, thereby allowing the cleaning assembly to pivot from a stowed position to at least one cleaning position, and wherein the mobile unit is operable to move the cleaning assembly along a surface when the cleaning assembly is in the cleaning position, and wherein the cleaning assembly comprises:
at least one nozzle configured to spray one or more cleaning fluids on the surface when the cleaning assembly is in the cleaning position; and
at least one brush configured to scrub the surface, wherein the brush is configured to selectively rotate about an axis of the brush and selectively tilt about the cleaning assembly.

2. The mobile cleaning system of claim 1, wherein the cleaning assembly is in the cleaning position when the cleaning assembly is selectively pivoted to a vertical position.

3. The mobile cleaning system of claim 1, wherein the cleaning assembly is in the stowed position when the cleaning assembly is selectively pivoted to a horizontal position.

4. The mobile cleaning system of claim 1, further comprising a hand-held spray system operable to selectively spray one or more cleaning fluids on the surface independently of the cleaning assembly.

5. The mobile cleaning system of claim 1, further comprising one or more fluid tanks for supplying the one or more cleaning fluids to the cleaning assembly.

6. The mobile system of claim 5, wherein the one or more cleaning fluids comprises water and the one or more fluid tanks comprises one or more water tanks.

7. The mobile system of claim 5, wherein the one or more cleaning fluids comprises a detergent and the one or more fluid tanks comprises a detergent tank.

8. The mobile system of claim 5, further comprising a splash shield operable to inhibit splashing of the at least one cleaning fluid into the mobile unit.

9. A mobile cleaning system useful for cleaning a vehicle surface, the mobile cleaning system comprising:
a mobile unit comprising:
a motor operable to cause movement of the mobile unit; and
an operator assembly comprising one or more controls for selectively operating the mobile cleaning system;
a cleaning assembly pivotally coupled to the mobile unit, wherein the cleaning assembly comprises:
a fluid applicator operable to apply at least one cleaning fluid to the vehicle surface; and
at least one brush operable to scrub the vehicle surface after application of the cleaning fluid to the vehicle surface, thereby cleaning the vehicle surface; and
a cleaning fluid supply system fluidically connected to the cleaning assembly, the cleaning fluid supply system comprising:
at least one cleaning fluid tank configured to store the cleaning fluid; and
a cleaning fluid pump fluidically connected to the fluid tank and operable to supply the cleaning fluid to the cleaning assembly for application by the fluid applicator.

10. The mobile cleaning system of claim 9, wherein the fluid applicator is a spray boom comprising at least one nozzle for applying the cleaning fluid to the surface.

11. The mobile cleaning system of claim 9, wherein the cleaning assembly is in the cleaning position when the cleaning assembly is selectively pivoted to a vertical position.

12. The mobile cleaning system of claim 9, wherein the cleaning assembly is in the stowed position when the cleaning assembly is selectively pivoted to a horizontal position.

13. The mobile cleaning system of claim 9, further comprising a hand-held spray system operable to selectively spray at least one cleaning fluid on the vehicle surface independently of the cleaning assembly.

14. The mobile cleaning system of claim 9, further comprising at least one fluid tank for supplying the at least one cleaning fluid to the cleaning assembly.

15. The mobile system of claim 14, wherein the at least one cleaning fluid comprises water and the at least one fluid tank comprises a water tank.

16. The mobile system of claim 14, wherein the at least one cleaning fluid comprises a detergent and the at least one fluid tank comprises a detergent tank.

17. The mobile system of claim 9, further comprising a splash shield operable to inhibit splashing of the at least one cleaning fluid into the mobile unit.

18. A mobile cleaning system useful for cleaning a vehicle surface, the mobile cleaning system comprising:
a mobile unit comprising:
a motor operable to cause movement of the mobile unit; and
an operator assembly comprising one or more controls for selectively operating the mobile cleaning system; and
a cleaning assembly pivotally coupled to the mobile unit, wherein the cleaning assembly is operable to selectively pivot between a stow position and at least one cleaning position, wherein the cleaning assembly comprises a fluid applicator operable to apply at least one cleaning fluid to the vehicle surface.

19. The mobile cleaning system of claim 18, further wherein the cleaning assembly comprises at least one brush operable to scrub the vehicle surface.

20. The mobile cleaning system of claim 19, further comprising a hand-held spray assembly operable for applying at least one cleaning fluid interpedently of the cleaning assembly.
